(19) United States
(12) Patent Application Publication
(10) Pub. No.: US 2024/0085950 A1
(43) Pub. Date: Mar. 14, 2024

(54) DOCKING STATION

(71) Applicant: FULLINK TECHNOLOGY CO., LTD., Shenzhen, Guangdong (CN)

(72) Inventors: Jie XIAO, Shenzhen, Guangdong (CN); Juan LIN, Shenzhen, Guangdong (CN)

(21) Appl. No.: 18/274,876

(22) PCT Filed: Jan. 29, 2021
(86) PCT No.: PCT/CN2021/074389

§ 371 Date: Jul. 28, 2023

(51) Int. Cl. G06F 1/16; H01R 12/77; H01R 13/453; H01R 13/502; H01R 27/02; H01R 31/06

(52) U.S. Cl. CPC G06F 1/1632; H01R 12/778; H01R 13/4538; H01R 13/502; H01R 27/02; H01R 31/065

(57) ABSTRACT

The present application discloses a docking station, which includes a docking body (100) and a male connector (200); the male connector (200) includes a connecting body (210), a male plug (220), a pushing button (230), and a limiting block (240); the male plug (220) is matched with the opening (1021), the pushing button (230) is fitted with the first sliding slot (1031) to drive the male connector (200) to switch between an accommodated state and an exposed state; and the male plug (220) is accommodated inside the opening (1021) and the limiting block (240) is elastically limited in the first limiting groove (1011), when the male connector (200) is in the accommodated state. The male plug (220) can be accommodated inside the opening (1021) when the docking station is accommodated, the accommodated state is stable, and the risk of damage to the male connector (200) is reduced.

### CROSS REFERENCE TO RELATED APPLICATION

This application is a National Stage Appl. filed under 35 USC 371 of International Patent Application No. PCT/CN2021/074389 with an international filing date of Jan. 29, 2021, designating the United States, now pending. The contents of the aforementioned application are incorporated herein by reference.

### TECHNICAL FIELD

The present application relates to the technical field of docking stations, and more particularly to a docking station.

### BACKGROUND

The docking station is generally electrically connected to an electronic product such as a notebook, a tablet, etc. through a male connector to expand interfaces. However, the male connector of the existing docking station is generally inconvenient to be accommodated and easy to be damaged.

### SUMMARY

One of the objects of embodiments of the present application is to provide a docking station, in order to solve the problem that the male connector of the existing docking station is inconvenient to be accommodated and easy to be damaged.

In order to solve above technical problem, the technical solution adopted in the embodiment of the present application is as followed:

In a first aspect, a docking station is provided, which includes:

a docking body, provided with an accommodating cavity and a first side surface and a second side surface adjacent to the first side surface, the first side surface of the docking body is provided with an opening arranged in communication with the accommodating cavity, the second side surface is provided with a first sliding slot arranged in communication with the accommodating cavity, and a cavity wall of the accommodating cavity of the docking body is provided with a first limiting groove; and

a male connector, including a connecting body accommodated in the accommodating cavity, a male plug, a pushing button, and a limiting block that are connected to the connecting body; the male plug is matched with the opening, the pushing button is fitted with the first sliding slot to drive the male connector to switch between an accommodated state and an exposed state; the male plug is penetrated through the opening to be exposed when the male connector is in the exposed state; and the male plug is accommodated inside the opening and the limiting block is elastically limited in the first limiting groove, when the male connector is in the accommodated state.

In an embodiment, the cavity wall of the accommodating cavity of the docking body is further provided with a second limiting groove spaced apart from the first limiting groove, a layout path from the second limiting groove to the first limiting groove is parallel to an extension direction of the first sliding slot; and the male plug is penetrated through the opening to be exposed and the limiting block is limited in the second limiting groove, when the male connector is in the exposed state.

In an embodiment, the pushing button and the limiting block are arranged at a same side of the connecting body.

In an embodiment, the male connector further includes a movable plate with one end rotatably connected with the connecting body, and an elastic member elastically held between the movable plate and the connecting body; and the pushing button and the limiting block are arranged at a side of the movable plate facing away from the connecting body.

In an embodiment, the elastic member is positioned in alignment with the pushing button.

In an embodiment, a side of the movable plate facing away from the pushing button is provided with a first accommodating hole configured for accommodating a part of the elastic member, and a side of the connecting body facing the movable plate is provided with a second accommodating hole configured for accommodating a part of the elastic member.

In an embodiment, the movable plate is provided with a rotating end rotatably connected with the connecting body and a free end opposite to the rotating end, the limiting block is arranged at the free end, and the pushing button is arranged at a middle of the limiting block and the rotating end.

In an embodiment, the docking body includes:

a housing assembly, including a first housing and a second housing detachably connected to each other, and the first housing and the second housing are jointly enclosed to form the accommodating cavity, the first housing is provided with a plurality of expansion ports arranged in communication with the accommodating cavity, and the second housing is provided with the opening and the first sliding slot;

a circuit board, accommodated in the accommodating cavity, and the circuit board is connected with a plurality of docking interfaces matched with the plurality of expansion ports in a one-to-one manner, and the circuit board is electrically connected with the male connector.

In an embodiment, the housing assembly further includes a separating plate detachably connected with the second housing, and the separating plate is arranged between the circuit board and the male connector, and the separating plate is configured for dividing the accommodating cavity into a first cavity arranged in the first housing and configured for accommodating the circuit board, and a second cavity arranged in the second housing and configured for accommodating the male connector.

In an embodiment, the male connector is electrically connected with the circuit board through an electrical connection structure, the separating plate is provided with a second sliding slot, an extension direction of the second sliding slot is parallel to an extension direction of the first sliding slot, the second sliding slot is arranged penetrating through a depth direction of the second sliding slot, and the electrical connection structure is inserted in and connected to the second sliding slot.

In an embodiment, the electrical connection structure is a flexible circuit board.

In an embodiment, a side of the separating plate facing the first housing is provided with a first insertion groove, and the first insertion groove is configured for enabling the circuit board to be plugged therein.

In an embodiment, the second housing is provided with a first sliding rail and a second sliding rail opposite to each other, the first sliding rail and the second sliding rail are arranged away from an end portion of the first side surface and in communication with an outside, and the separating plate is capable of sliding between the first sliding rail and the second sliding rail.

In an embodiment, one of the first housing and the second housing is convexly provided with an engagement structure and the other of the first housing and the second housing is concavely provided with an engagement groove configured for matching with the engagement structure.

In an embodiment, one side of the first housing is provided with the expansion ports, an inner side of the other side of the first housing is provided with a third sliding rail, the third sliding rail is arranged adjacent to an end portion of the second housing and in communication with the outside, and the circuit board is capable of sliding on the third sliding rail.

In an embodiment, the first housing includes a housing body and an end plate detachably connected to a side of the housing body away from the second housing, a side of the end plate facing the housing body is provided with a second insertion groove, and the second insertion groove is configured for enabling the circuit board to be plugged therein.

The beneficial effects of the docking station provided by the embodiment of the present application are that:

When the docking station provided by the embodiment of the present is accommodated, the male connector can be switched from the exposed state to the accommodated state by pushing the pushing button, so as to accommodate the male plug inside the opening, thus the entire male connector can be accommodated in the accommodating cavity. Moreover, the male connector can be stabilized in the accommodated state without an external force by elastically limiting the limiting block in the first limiting groove; based on this, the accommodation and protection of the male plug can be reliably achieved when the docking station is not used, thus the accommodation and protection of the male connector is realized, the risk of damage to the male connector can be reduced, the service performance of the docking station can be ensured in a certain degree, and the service life of the docking station is extended.

### BRIEF DESCRIPTION OF THE DRAWINGS

In order to explain the embodiments of the present application more clearly, a brief introduction regarding the accompanying drawings that need to be used for describing the embodiments of the present application or the prior art is given below; it is obvious that the accompanying drawings described as follows are only some embodiments of the present application, for those skilled in the art, other drawings can also be obtained according to the current drawings on the premise of paying no creative labor.

FIG. 1 is a first schematic perspective view of a docking station provided by an embodiment of the present application;

FIG. 2 is a second schematic perspective view of a docking station provided by an embodiment of the present application;

FIG. 3 is a schematic view of a male connector in an accommodated state provided by an embodiment of the present application;

FIG. 4 is a schematic view of a male connector switching from an accommodated state to an exposed state provided by an embodiment of the present application;

FIG. 5 is a schematic view of a male connector in an exposed state provided by an embodiment of the present application;

FIG. 6 is an exploded view of a docking station provided by an embodiment of the present application;

FIG. 7 is a schematic view of an assembly of a second housing, a separating plate and a male connector provided by an embodiment of the present application;

FIG. 8 is a first exploded view of a second housing, a separating plate and a male connector provided by an embodiment of the present application;

FIG. 9 is a second exploded view of a second housing, a separating plate and a male connector provided by an embodiment of the present application; and

FIG. 10 is a schematic perspective view of a first housing provided by an embodiment of the present application.

In the drawings, the reference numerals are listed:

100—docking body, 101—accommodating cavity, 1011—first limiting groove, 1012—second limiting groove, 1013—first cavity, 1014—second cavity; 102—first side surface, 1021—opening; 103—second side surface, 1031—first sliding slot; 110—housing assembly, 111—first housing, 1111—expansion port, 1112—engagement groove, 1113—third sliding rail, 1114—housing body, 1115—end plate, 1116—second insertion groove; 112—second housing, 1121—first sliding rail, 1122—second sliding rail, 1123—engagement structure; 113—separating plate, 1131—second sliding slot, 1132—first insertion groove; 120—circuit board, 121—docking interface; 200—male connector, 210—connecting body, 211—second accommodating hole, 220—male plug, 230—pushing button, 240—limiting block, 250—movable plate, 251—first accommodating hole, 252—rotating end, 253—free end, 260—elastic member, 270—electrical connection structure.

### DETAILED DESCRIPTION OF EMBODIMENTS

In order to make the purpose, the technical solution and the advantages of the present application be clearer and more understandable, the present application will be further described in detail below with reference to accompanying figures and embodiments. It should be understood that the specific embodiments described herein are merely intended to illustrate but not to limit the present application.

In the description of the present application, it needs to be understood that, directions or location relationships indicated by terms such as “length”, “width”, “up”, “down”, “front”, “rear”, “left”, “right”, “vertical”, “horizontal”, “top”, “bottom”, “inside”, “outside”, and so on are the directions or location relationships shown in the accompanying figures, which are only intended to describe the present application conveniently and simplify the description, but not to indicate or imply that an indicated device or component must have specific locations or be constructed and manipulated according to specific locations; therefore, these terms shouldn't be considered as any limitation to the present application.

In addition, terms “the first” and “the second” are only used in describe purposes, and should not be considered as indicating or implying any relative importance, or impliedly indicating the number of indicated technical features. As such, technical feature(s) restricted by “the first” or “the second” can explicitly or impliedly include one or more such technical feature(s). In the description of the present application, “a plurality of” means two or more, unless there is additional explicit and specific limitation.

In the present application, unless there is additional explicit stipulation and limitation, terms such as “mount”, “connect with each other”, “connect”, “fix”, and so on should be generally interpreted, for example, “connect” can be interpreted as being fixedly connected, detachably connected, or connected integrally; “connect” can also be interpreted as being mechanically connected or electrically connected; “connect” can be further interpreted as being directly connected or indirectly connected through intermediary, or being internal communication between two components or an interaction relationship between the two components. For the one of ordinary skill in the art, the specific meanings of the aforementioned terms in the present application can be interpreted according to specific conditions.

In order to make the purpose, the technical solution and the advantages of the present application be clearer and more understandable, herein, the present application is further described in detail below with reference to accompanying figures and embodiments.

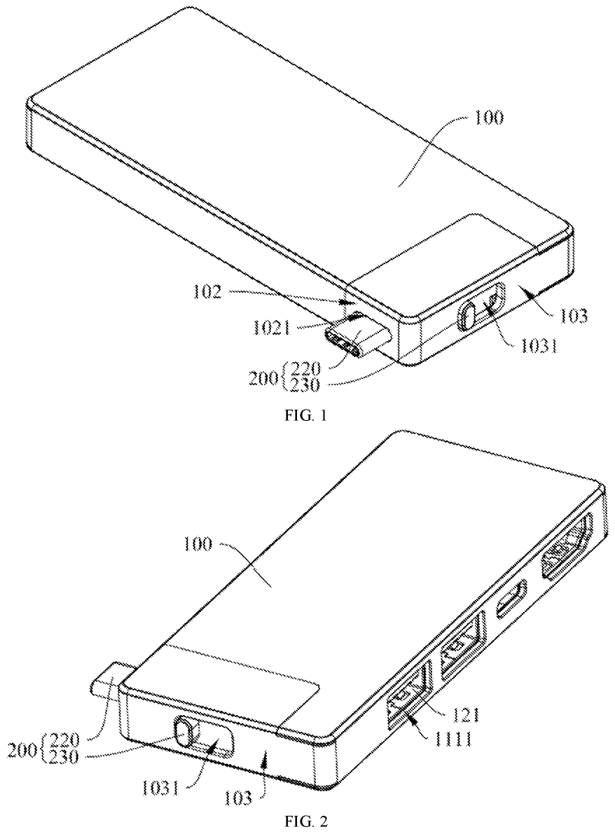

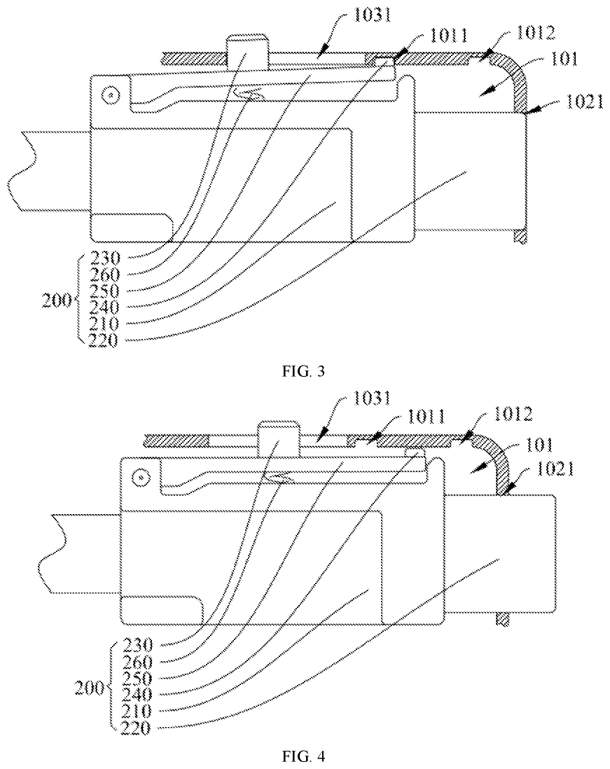

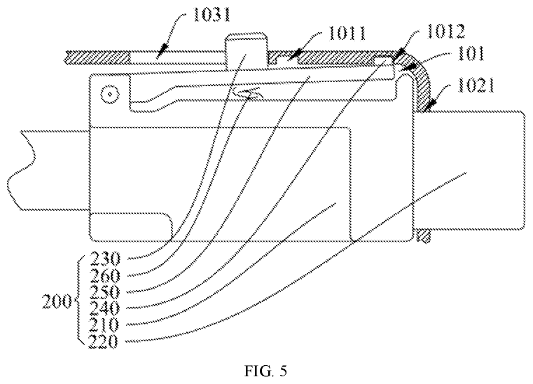

As shown in FIG. 1, FIG. 3, FIG. 4, and FIG. 5, some embodiments of the present application provide a docking station, the docking station includes a docking body 100 and a male connector 200. The docking body 100 is provided with an accommodating cavity 101, and a first side surface 102 and a second side surface 103 adjacent to the first side surface 102, the first side surface 102 of the docking body 100 is provided with an opening 1021 arranged in communication with the accommodating cavity 101, and the second side surface 102 is provided with a first sliding slot 1031 arranged in communication with the accommodating cavity 101, a cavity wall of the accommodating cavity 101 of the docking body 100 is further provided with a first limiting groove 1011; the male connector 200 includes a connecting body 210 accommodated in the accommodating cavity 101, a male plug 220, a pushing button 230 and a limiting block 240 that are all connected to the connecting body 210. The male plug 220 is matched with the opening 1021. The pushing button 230 is slid in and fitted with the first sliding slot 1031 to drive the male connector 200 to switch between an accommodated state and an exposed state. When the male connector 200 is in the exposed state, the male plug 220 is penetrated through the opening 1021 and to be exposed, and when the male connector 200 is in the accommodated state, the male plug 220 is accommodated inside the opening 1021, and the limiting block 240 is elastically limited in the first limiting groove 1011.

It should be noted here that the adjacent first side surface 102 and second side surface 103 are basically perpendicular to each other. Based on this, the penetrating path of opening 1021 on the first side surface 102 can be basically parallel to the second side surface 103, so that it is convenient to arrange the first sliding slot 1031 on the second side surface 103 for guiding a moving path of the male connector 200. Optionally, the extension path of the first sliding slot 1031 is parallel to the penetrating path of the opening 1021, so that the male plug 220 can be smoothly extended and retracted relative to the opening 1021, the risk of stuck is reduced.

It should also be noted here that the extension length of the first sliding slot 1031 limits the sliding range of the pushing button 230 in the first sliding slot 1031, specifically, the pushing button 230 can be slid back and forth in the first sliding slot 1031 by pushing the pushing button 230, such that the male connector 200 can be enabled to switch between the accommodated state and the exposed state. When the male connector 200 switches from the accommodated state to the exposed state, the pushing button 230 drives the male connector 200 to move in the direction close to the opening 1021, until the male plug 220 extends out from the opening 1021, and is at least partially exposed to the opening 1021, at this time, the male plug 220 can be used to electrically connect with electronic products such as notebooks and tablets to use the docking station. Conversely, when the male connector 200 switches from the exposed state to the accommodated state, the pushing button 230 moves the male connector 200 away from the opening 1021, until the male plug 220 is accommodated inside the opening 1021, that is, accommodated in the accommodating cavity 101, at this time, the accommodation and protection of the male plug 220 can be realized, that is, the accommodation and protection of the male connector 200 are realized.

It should also be noted that when the male connector 200 is in the accommodated state, the limiting block 240 can be elastically limited in the first limiting groove 1011. Based on this, the male connector 200 can be stabilized in the accommodated state without sufficient external force, and can be pushed out from the first limiting groove 1011 when there is sufficient pushing force, and move synchronously with the male connector 200. Thus, the accommodated effect of the male connector 200 in the accommodated state can be guaranteed, and the risk of damage caused by the male plug 220 being mistakenly thrown out can be reduced.

In summary, when the docking station provided by the embodiment of the present is accommodated, the male connector 200 can be switched from the exposed state to the accommodated state by pushing the pushing button 230, so as to accommodate the male plug 220 inside the opening 1021, thus the entire male connector 200 can be accommodated in the accommodating cavity 101. Moreover, the male connector 200 can be stabilized in the accommodated state without the sufficient external force by elastically limiting the limiting block 240 in the first limiting groove 1011; based on this, the accommodation and protection of the male plug 220 can be reliably achieved when the docking station is not used, thus the accommodation and protection of the male connector 200 is realized, the risk of damage to the male connector 200 can be reduced, the service performance of the docking station can be ensured in a certain degree, and the service life of the docking station is extended.

Alternatively, the docking station can be miniaturized or even reduced to the size of a bank card, which can improve the portability and accommodation convenience of the docking station.

As shown in FIG. 3, FIG. 4, and FIG. 5, in the embodiment, the cavity wall of the accommodating cavity 101 of the docking body 100 is further provided with a second limiting groove 1012 spaced apart from the first limiting groove 1011, a layout path from the second limiting groove 1012 to the first limiting groove 1011 is parallel to an extension direction of the first sliding slot 1031; and the male plug 220 is penetrated through the opening 1021 to be exposed and the limiting block 240 is limited in the second limiting groove 1012, when the male connector 200 is in the exposed state.

It should be noted here that when pushing button 230 forces the male connector 200 from the accommodated state to the exposed state, the limiting block 240 can exit the first limiting groove 1011 and elastically limit in the second limiting groove 1012 when the limiting block 240 moves to the second limiting groove 1012. At this time, the male plug 220 has been extended from the opening 1021 and is at least partially exposed to the opening 1021. In addition, the male connector 200 can be stabilized in the exposed state when the limiting block 240 is elastically limited in the second limiting groove 1012 and there is no sufficient external force, which is easy to plug and unplug the male plug 220 and improve the performance of the male connector 200, that is, the performance of the docking station is improved.

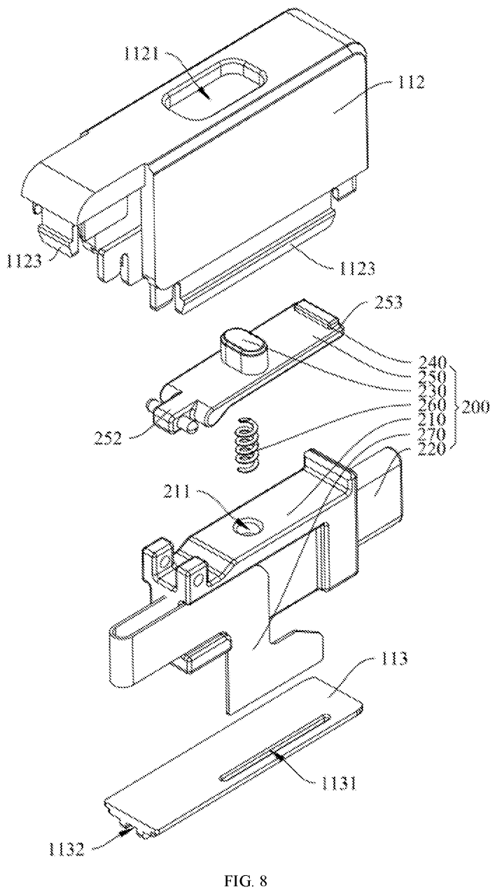

As shown in FIG. 3, FIG. 5, and FIG. 8, in the embodiment, the pushing button 230 and the limiting block 240 are arranged at a same side of the connecting body 210.

By adopting the above solution, the arrangement of the pushing button 230 and the first sliding slot 1031 cooperated with the pushing button 230 can be referred to directly plan and design the arrangement of the pushing button 230, the first limiting groove 1011 and the second limiting groove 1012 cooperated with the pushing button 230, so as to reduce the design difficulty and beneficial to improve the fit accuracy between the pushing button 230 and the first sliding slot 1031, as well as the limiting block 240 and the first limiting groove 1011 and the second limiting groove 1012.

As shown in FIG. 3, FIG. 5, and FIG. 8, in the embodiment, the male connector 200 further includes a movable plate 250 with one end rotatably connected with the connecting body 210, and an elastic member 260 elastically held between the movable plate 250 and the connecting body 210; and the pushing button 230 and the limiting block 240 are arranged at a side of the movable plate 250 facing away from the connecting body 210.

It should be noted here that when the pushing button 230 is subjected to a pressing force, the pressing force can cause the movable plate 250 to rotate to the side close to the connecting body 210 and compress the elastic member 260, and then the limiting block 240 exits out the first limiting groove 1011 or the second limiting groove 1012, then the pushing button 230 can be moved to drive the male connector 200 to switch between the accommodated state and the exposed state; during the switching, if the limiting block 240 is not moved to the first limiting groove 1011 or the second limiting groove 1012 and the pressing force is not removed, although the limiting block 240 can elastically abut against the cavity wall of the accommodating cavity 101 under the action of the elastic member 260, but it will not hinder the movement of the male connector 200. If the limiting block 240 is moved to the first limiting groove 1011 or the second limiting groove 1012 and the pressing force is removed, the elastic member 260 can recover the elastic deformation and push the limiting block 240 so that the limiting block 240 elastically limited in the first limiting groove 1011 or the second limiting groove 1012, the male connector 200 is stable in the accommodated state or the exposed state.

Therefore, by adopting the above scheme, the limiting block 240 can be elastically limited in the first limiting groove 1011 or the second limiting groove 1012 by the elastic member 260, and the limiting block 240 can release the limiting relationship with the first limiting groove 1011 or the second limiting groove 1012 by the pushing button 230. Based on this, on the basis of ensuring the state stability of the male connector 200 in the accommodated state and the exposed state, the operation convenience of switching between the male connector 200 in the accommodated state and the exposed state can be improved, thus the service performance of the docking station is improved.

The movable space of the movable plate 250 does not need to be too large to ensure that the pushing button 230 will not completely exit the first sliding slot 1031 when being pressed, which can ensure the performance of the docking station.

As shown in FIG. 3, FIG. 5, and FIG. 8, in the embodiment, the elastic member 260 is positioned in alignment with the pushing button 230.

By adopting the above scheme, the pressing force acting on the pushing button 230 can be directly concentrated on the elastic member 260, which facilitates the elastic member 260 to quickly and instantly deform under the action of the pressing force. Thus, the movable plate 250 can be made to rotate quickly and instantly to a certain extent, and drive the limiting block 240 to exit out of the first limiting groove 1011 or the second limiting groove 1012, the convenience and smoothness of related operations can be improved, the risk of stuck is reduced, and thus improve the performance of the docking station.

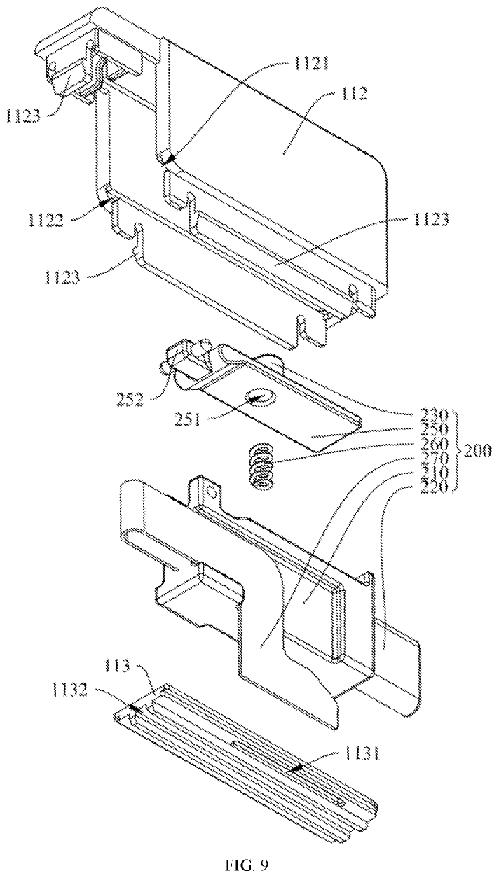

As shown in FIG. 8 and FIG. 9, in the present embodiment, a side of the movable plate 250 facing away from the pushing button 230 is provided with a first accommodating hole 251 configured for accommodating a part of the elastic member 260, and a side of the connecting body 210 facing the movable plate 250 is provided with a second accommodating hole 211 configured for accommodating a part of the elastic member 260.

By adopting the above scheme, one end of the elastic member 260 can be accommodated and limited in the first accommodating hole 251, the other end of the elastic member 260 is accommodated and limited in the second accommodating hole 211, and then the elastic member 260 is held between the movable plate 250 and the connecting body 210. Based on this, it can help stabilize the relative position relationship between the elastic member 260 and the movable plate 250 as well as the connecting body 210, the risk of the elastic member 260 being separated from the movable plate 250 and the connecting body 210 during the elastic deformation and the recovery of elastic deformation is reduced, thus ensuring the service performance of the male connector 200 and the service performance of the docking station, and the service life of the docking station is extended.

As shown in FIG. 3, FIG. 5, and FIG. 8, in the embodiment, the movable plate 250 is provided with a rotating end 252 rotatably connected with the connecting body 210 and a free end 253 opposite to the rotating end 252, the limiting block 240 is arranged at the free end 253, and the pushing button 230 is arranged at a middle of the limiting block 240 and the rotating end 252.

By adopting the above scheme, the force arm between the pushing button 230 and the elastic member 260 to the limiting block 240, as well as the force arm between the pushing button 230 and the elastic member 260 to rotating end 252 can be balanced, so as to achieve a labor-saving effect, and to achieve a smaller pressing force to drive the movable plate 250 to rotate around the rotating end 252, and basically drive the limiting block 240 away from the first limiting groove 1011 or the second limiting groove 1012 at the same time, thus improving the operation convenience of related operations. The service performance of the male connector 200 and the service performance of the docking station are improved.

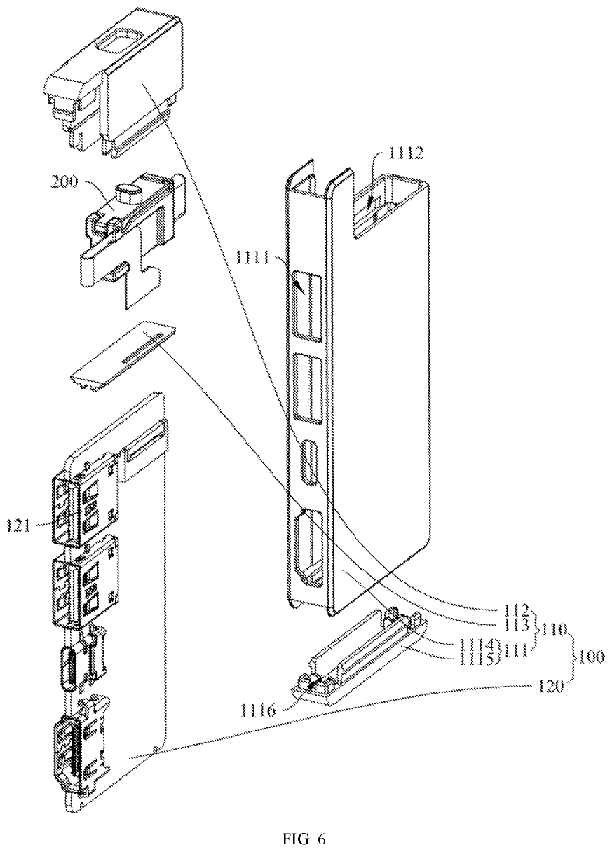

As shown in FIG. 1, FIG. 2, and FIG. 6, in the embodiment, the docking body 100 includes a housing assembly 110 and a circuit board 120, the housing assembly 110 includes a first housing 111 and a second housing 112 detachably connected to each other, and the first housing 111 and the second housing 112 are jointly enclosed to form the accommodating cavity 101, the first housing 111 is provided with a plurality of expansion ports 1111 arranged in communication with the accommodating cavity 101, and the second housing 112 is provided with the opening 1021 and the first sliding slot 1031; the circuit board 120 is accommodated in the accommodating cavity 101, and the circuit board 120 is connected with a plurality of docking interfaces 121 matched with the plurality of expansion ports 1111 in a one-to-one manner, and the circuit board 120 is electrically connected with the male connector 200.

It should be noted here that during assembly, the circuit board 120 can be firstly placed into the first housing 111, the docking interfaces 121 of circuit board 120 are matched with the expansion ports 1111 in a one-to-one manner, and the male connector 200 is then placed in the second housing 112, the male plug 220 is aligned with the opening 1021 and the pushing button 230 is slid and matched with the first sliding slot 1031, finally, the first housing 111 and the second housing 112 are detachably connected, and the assembly operation is very convenient. The male connector 200 is electrically connected with the circuit board 120, to realize the electrical connection of the male connector 200 to the docking interfaces 121.

Alternatively, the docking interfaces 121 can be, but are not limited to, a Secure Digital Memory Card (SD) interface or an Universal Serial Bus (USB) interface. Universal serial bus) Interface, a High Definition Multimedia Interface (HDMI), a Type-C interface (a connection interface of USB interface, which can be inserted regardless of both sides), and an Audio interface. The SD card interface can be used to plug and remove an SD card, the USB interface can be used to plug a USB flash drive, a mouse, a keyboard, or a mobile hard disk, etc., the HDMI interface can be used to plug devices such as the display screen, the Type-C interface can be used to plug devices to be charged for fast charging, and the Audio interface can be used to plug devices such as headphones.

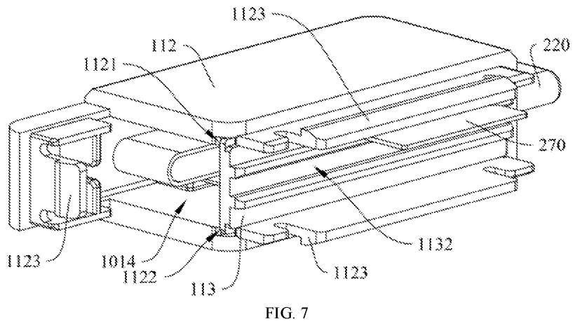

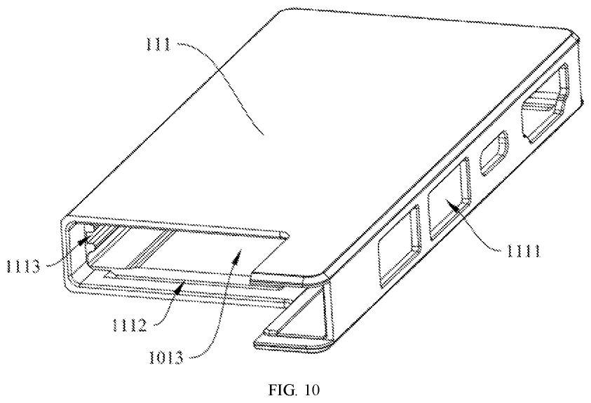

As shown in FIG. 6, FIG. 7, and FIG. 10, in the embodiment, the housing assembly 110 further includes a separating plate 113 detachably connected with the second housing 112, and the separating plate 113 is arranged between the circuit board 120 and the male connector 200, and the separating plate 113 is configured for dividing the accommodating cavity 101 into a first cavity 1013 arranged in the first housing 111 and configured for accommodating the circuit board 120, and a second cavity 1014 arranged in the second housing 112 and configured for accommodating the male connector 200.

By adopting the above scheme, the first cavity 1013 accommodating the circuit board 120 can be relatively separated from the second cavity 1014 accommodating the male connector 200. Based on this, the interference between the circuit board 120 and the male connector 200 can be reduced to a certain extent, especially when the male connector 200 is switched between the accommodated state and the exposed state, the influence of the movement of the male connector 200 to the circuit board 120 is reduced. Thus the service performance of the docking station is improved, and the service life of the docking station is extended.

As shown in FIG. 6, FIG. 7, and FIG. 8, in the embodiment, the male connector 200 is electrically connected with the circuit board 120 through an electrical connection structure 270, the separating plate 113 is provided with a second sliding slot 1131, an extension direction of the second sliding slot 1131 is parallel to an extension direction of the first sliding slot 1031, the second sliding slot 1131 is arranged penetrating through a depth direction of the second sliding slot 1131, and the electrical connection structure 270 is inserted in and connected to the second sliding slot 1131.

By adopting the above scheme, the electrical connection structure 270 can be inserted into the second sliding slot 1131, so as to realize the electrical connection between the male connector 200 and the circuit board 120, and when the male connector 200 switches between the accommodated state and the exposed state, the electrical connection structure 270 can then be moved in the second sliding slot 1131, and the electrical connection between the male connector 200 and the circuit board 120 is continuously disconnected, so that the stability and reliability of the electrical connection between the male connector 200 and the circuit board 120 are improved on the basis of reducing the interference between the circuit board 120 and the male connector 200.

As shown in FIG. 6, FIG. 7, and FIG. 8, in the embodiment, the electrical connection structure 270 is a flexible circuit board.

By adopting the above scheme, the stability and reliability of the electrical connection between the male connector 200 and the circuit board 120 can be improved by a flexible and stroke reserved flexible circuit board. Even the reciprocating sliding of the flexible circuit board in the second sliding slot 1131 can also improve the movement smoothness of the male connector 200 to a certain extent, so as to improve the service performance of the docking station.

As shown in FIG. 7, FIG. 8, and FIG. 9, in the embodiment, a side of the separating plate 113 facing the first housing 111 is provided with a first insertion groove 1132, and the first insertion groove 1132 is configured for enabling the circuit board 120 to be plugged therein.

By adopting the above scheme, the circuit board 120 can be inserted into the first insertion groove 1132 from the side close to the separating plate 113 during assembly, then the assembly is realized by detachable connection of the first housing 111 and the second housing 112. Based on this, the position accuracy of the first housing 111, the separating plate 113, the second housing 112 and the circuit board 120 between each other can be improved, and the placement status and setting position of the circuit board 120 can be preliminarily stabilized by the first insertion groove 1132, so as to facilitate the maintenance of high-precision alignment between docking interfaces 121 and expansion ports 1111. It is beneficial to reduce the assembly difficulty of the docking station, improve the assembly efficiency and improve the service performance.

As shown in FIG. 7 and FIG. 9, in the embodiment, the second housing 112 is provided with a first sliding rail 1121 and a second sliding rail 1122 opposite to each other, the first sliding rail 1121 and the second sliding rail 1122 are arranged away from an end portion of the first side surface 102 and in communication with an outside, and the separating plate 113 is capable of sliding between the first sliding rail 1121 and the second sliding rail 1122.

By adopting the above scheme, the separating plate 113 slides into the first sliding rail 1121 and the second sliding rail 1122 from the end of the first sliding rail 1121 and the second sliding rail 1122 away from the first side surface 102, so as to conveniently and reliably connect to the second housing 112, the connection is reliable, the assembly operation is convenient, and the relative position between the separating plate 113 and the second housing 112 is fixed after assembly, thus improving the assembly efficiency and the service performance of the docking station.

As shown in FIG. 7, FIG. 8, and FIG. 9, in the embodiment, one of the first housing 111 and the second housing 112 is convexly provided with an engagement structure 1123 and the other of the first housing 111 and the second housing 112 is concavely provided with an engagement groove 1112 capable of matching with the engagement structure 1123.

By adopting the above scheme, each engagement structure 1123 can be engaged with each engagement groove 1112, which is convenient to achieve a reliable connection between the first housing 111 and the second housing 112, and maintain a relative fixed between the first housing 111 and the second housing 112, thus, the protective effect of first housing 111 and second housing 112 onto the circuit board 120 and the male connector 200 in the accommodating cavity 101 can be guaranteed. The service performance of the docking station is improved, and the service life of the docking station is extended.

As shown in FIG. 2, FIG. 6, and FIG. 10, in the embodiment, one side of the first housing 111 is provided with the expansion ports 1111, an inner side of the other side of the first housing 111 is provided with a third sliding rail 1113, the third sliding rail 1113 is arranged adjacent to an end portion of the second housing 112 and in communication with the outside, and the circuit board 120 is capable of sliding on the third sliding rail 1113.

By adopting the above scheme, the circuit board 120 can be slid into the third sliding rail 1113 from the side close to the second housing 112 during assembly. The relative position of the circuit board 120 relative to the second housing 112 is stable, further, the third sliding rail 1113 and the expansion ports 1111 are arranged on both sides of the second housing 112, such that the circuit board 120 can be stably placed relative to the second housing 112. Therefore, it is convenient to maintain the high-precision alignment between the docking interfaces 121 and the expansion ports 1111, and improve the service performance of the docking dock.

As shown in FIG. 6, in this embodiment, the first housing 111 includes a housing body 1114 and an end plate 1115 detachably connected to a side of the housing body 1114 away from the second housing 112, a side of the end plate 1115 facing the housing body 1114 is provided with a second insertion groove 1116, and the second insertion groove 1116 is configured for enabling the circuit board 120 to be plugged therein.

By adopting the above scheme, the end plate 1115 can be formed independently to facilitate the processing of the second insertion groove 1116, the housing body 1114 is then connected with the end plate 1115 to form the first housing 111, and the circuit board 120 is finally slid into the third sliding rail 1113 from the side close to the second housing 112, and the side of the circuit board 120 away from the second housing is inserted into the second insertion groove 1116, and the circuit board 120 is limited and accommodated in the second housing 112. Based on this, the third sliding rail 1113 and the second insertion groove 1116 can jointly maintain the arrangement position and placement state of the circuit board 120 relative to the second housing 112, that is, can improve the position stability and state stability of the circuit board 120 relative to the second housing 112, so as to facilitate the maintenance of high-precision alignment between the docking interfaces 121 and the expansion ports 1111, which can improve the service performance of the docking station.

The aforementioned embodiments are only preferred embodiments of the present application, and should not be regarded as being limitation to the present application. Any modification, equivalent replacement, improvement, and so on, which are made within the spirit and the principle of the present application, should be included in the protection scope of the present application.

What is claimed is:

1. A docking station, comprising:
a docking body, provided with an accommodating cavity, a first side surface, and a second side surface adjacent to the first side surface; wherein the first side surface of the docking body is provided with an opening arranged in communication with the accommodating cavity, the second side surface is provided with a first sliding slot arranged in communication with the accommodating cavity, and a cavity wall of the accommodating cavity of the docking body is provided with a first limiting groove; and
a male connector, comprising a connecting body accommodated in the accommodating cavity, and a male plug, a pushing button, and a limiting block that are connected to the connecting body; wherein the male plug is matched with the opening, the pushing button is fitted with the first sliding slot to drive the male connector to switch between an accommodated state and an exposed state; the male plug is penetrated through the opening to be exposed when the male connector is in the exposed state; and the male plug is accommodated inside the opening and the limiting block is elastically limited in the first limiting groove, when the male connector is in the accommodated state.

2. The docking station according to claim 1, wherein the cavity wall of the accommodating cavity of the docking body is further provided with a second limiting groove spaced apart from the first limiting groove, a layout path from the second limiting groove to the first limiting groove is parallel to an extension direction of the first sliding slot; and when the male connector is in the exposed state, the male plug is penetrated through the opening to be exposed and the limiting block is limited in the second limiting groove.

3. The docking station according to claim 1, wherein the pushing button and the limiting block are arranged at a same side of the connecting body.

4. The docking station according to claim 3, wherein the male connector further comprises a movable plate with one end rotatably connected with the connecting body, and an elastic member elastically held between the movable plate and the connecting body; and the pushing button and the limiting block are arranged at a side of the movable plate facing away from the connecting body.

5. The docking station according to claim 4, wherein the elastic member is positioned in alignment with the pushing button.

6. The docking station according to claim 5, wherein a side of the movable plate facing away from the pushing button is provided with a first accommodating hole configured for accommodating a part of the elastic member, and a side of the connecting body facing the movable plate is provided with a second accommodating hole configured for accommodating a part of the elastic member.

7. The docking station according to claim 5, wherein the movable plate is provided with a rotating end rotatably connected with the connecting body and a free end opposite to the rotating end, the limiting block is arranged at the free end, and the pushing button is arranged at a middle of the limiting block and the rotating end.

8. The docking station according to claim 1, wherein the docking body comprises:
a housing assembly, comprising a first housing and a second housing detachably connected to each other, and wherein the first housing and the second housing are jointly enclosed to form the accommodating cavity, the first housing is provided with a plurality of expansion ports arranged in communication with the accommodating cavity, and the second housing is provided with the opening and the first sliding slot;
a circuit board, accommodated in the accommodating cavity, and wherein the circuit board is connected with a plurality of docking interfaces matched with the plurality of expansion ports in a one-to-one manner, and the circuit board is electrically connected with the male connector.

9. The docking station according to claim 8, wherein the housing assembly further comprises a separating plate detachably connected with the second housing, and the separating plate is arranged between the circuit board and the male connector, and the separating plate is configured for dividing the accommodating cavity into a first cavity arranged in the first housing and configured for accommodating the circuit board, and a second cavity arranged in the second housing and configured for accommodating the male connector.

10. The docking station according to claim 9, wherein the male connector is electrically connected with the circuit board through an electrical connection structure, the separating plate is provided with a second sliding slot, an extension direction of the second sliding slot is parallel to an extension direction of the first sliding slot, the second sliding slot is arranged penetrating through a depth direction of the second sliding slot, and the electrical connection structure is inserted in and connected to the second sliding slot.

11. The docking station according to claim 10, wherein the electrical connection structure is a flexible circuit board.

12. The docking station according to claim 9, wherein a side of the separating plate facing the first housing is provided with a first insertion groove, and the first insertion groove is configured for enabling the circuit board to be plugged therein.

13. The docking station according to claim 9, wherein the second housing is provided with a first sliding rail and a second sliding rail opposite to each other, the first sliding rail and the second sliding rail are arranged away from an end portion of the first side surface and in communication with an outside, and the separating plate is capable of sliding between the first sliding rail and the second sliding rail.

14. The docking station according to claim 8, wherein one of the first housing and the second housing is convexly provided with an engagement structure and the other of the first housing and the second housing is concavely provided with an engagement groove configured for matching with the engagement structure.

15. The docking station according to claim 8, wherein one side of the first housing is provided with the plurality of expansion ports, an inner side of the other side of the first housing is provided with a third sliding rail, the third sliding rail is arranged adjacent to an end portion of the second housing and in communication with the outside, and the circuit board is capable of sliding on the third sliding rail.

16. The docking station according to claim 15, wherein the first housing comprises a housing body and an end plate detachably connected to a side of the housing body away from the second housing, a side of the end plate facing the housing body is provided with a second insertion groove, and the second insertion groove is configured for enabling the circuit board to be plugged therein.
